(19) United States
(12) Patent Application Publication
(10) Pub. No.: US 2026/0181534 A1
(43) Pub. Date: Jun. 25, 2026

(54) TRACKING AND REACHABILITY ON NON-3GPP DEVICES

(71) Applicant: InterDigital Patent Holdings, Inc., Wilmington, DE (US)

(72) Inventors: Zhibi Wang, Woodbridge, IL (US); Samir Ferdi, Kirkland (CA); Michael Starsinic, Newtown, PA (US); Michel Roy, Candiac (CA); Ulises Olvera-Hernandez, Saint-Lazare (CA); Mohamad Kenan Al-Hares, Canterbury (GB); Anuj Sethi, Ottawa (CA)

(73) Assignee: InterDigital Patent Holdings, Inc., Wilmington, DE (US)

(21) Appl. No.: 18/990,395

(22) Filed: Dec. 20, 2024

(51) Int. Cl. H04W 48/16; H04W 76/10; H04W 76/30

(52) U.S. Cl. CPC H04W 48/16; H04W 76/10; H04W 76/30

(57) ABSTRACT

The disclosed embodiments enable a non-3GPP device to be reached by a peer device when the non-3GPP device connects to a 3GPP network via a UE/5G-RG. The embodiments enable the non-3GPP to be temporarily associated to any network subscription. As the non-3GPP device is linked or unlinked from different UE/5G-RG s at different times,. The embodiments enable an AF and a peer node to subscribe to reachability notifications associated with the non-3GPP device. A 3GPP PCF enables device reachability notifications by updating a UDR/UDM and a NEF based on a connection status of an non-3GPP device.

### BACKGROUND

In modern communication networks, tracking and maintaining reachability of devices are critical for ensuring reliable connectivity and efficient resource utilization. Non-3GPP devices, such as those operating in Wi-Fi, LoRaWAN, or other unlicensed spectrum technologies, are increasingly integrated into heterogeneous network environments, including 5G and beyond. These devices often rely on gateways or intermediaries to communicate with cellular core networks, creating challenges in monitoring their location and maintaining consistent reachability.

Traditional tracking mechanisms designed for 3GPP-compliant devices, such as those based on location updates and paging procedures, may not be directly applicable to non-3GPP devices. This disparity can lead to inefficiencies in device registration, session management, and service continuity. Furthermore, as the number of non-3GPP devices continues to grow, there is a pressing need for innovative solutions to address these challenges while ensuring seamless interoperability and quality of service across diverse network architectures.

The reachability of a wireless device may be conditional on both 1) the device (i.e. UE) being reachable, and 2) the device being associated with an established PDU Session.

A user may have many connected devices having different access technologies including both 3GPP based access technologies and non-3GPP access technologies. Each device may have a different device ID. The device IDs may be static, dynamic, based on context or usage, based on subscription, etc.

Connected devices may generally be classified in two categories: 1) communication devices that allow communications with a user (e.g., voice, video, texting, etc.), and 2) non-communication (NC) devices that do not allow communications with a user (i.e. these NC devices can only be tracked).

One or more devices (IoT, wearables, etc.) without their own subscription can be connected via a gateway UE or a Residential Gateway (5G-RG) to the network. A 5G-RG may be an upgraded version of the traditional RG and is connected as a UE to the 5G core network through a fixed or mobile network. An existing UE may connect multiple non- 3GPP devices from different users to allow the non- 3GPP devices to access the 3GPP network. By identifying the devices and linking the User Identity (or Device Global ID) to a subscription, the 3GPP system can enable non-3GPP devices to connect to the 3GPP network.

Introduced by User Identity Authentication (UIA) use cases, a non-3GPP User Identity (or Device Global ID) can be loosely coupled with any UE from which it obtains network service. Therefore, the non-3GPP Device Global ID can be switched to a different UE/subscription at any time. The UE/5G-RG subscription UDR can be a linked/unlinked device information profile. This means that reaching or locating the user with a non-3GPP device based on the UE ID may not be possible, as the non-3GPP device may be associated to a different (and undetermined) UE/subscription with a same or even different PLMN.

It is assumed that a non-3GPP Device Global ID is a globally unique identifier and uniquely identifies a non-3GPP device and is not statically assigned to a particular UE/subscription. At the same time, a non-3GPP device can be bound with a User Plane Address at the UE/5G-RG to uniquely identify the traffic generated by different non-3GPP devices connected through the same UE. When a non-3GPP device is connected to a UE, the UE may bind a User Plane Address to the non-3GPP device to identify and differentiate the traffic to/from the non-3GPP devices with different traffic characteristics, such as QoS.

### SUMMARY

A Policy Control Function (PCF) and a method for use in a Third Generation Partnership Project (3GPP) wireless network are disclosed. The PCF may comprise a transceiver and at least one processor. The transceiver and the at least one processor are configured to receive a request for a packet data unit (PDU) session establishment or modification from a user equipment (UE) or 5G residential gateway (5G-RG) through which a non- 3GPP device is connecting. The transceiver and the at least one processor are also configured to transmit a reachability notification message to a network exposure function (NEF) based on receiving the request for establishment of the PDU session from the non-3GPP device. The reachability notification message may indicate to the NEF that the non-3GPP device is reachable.

In some embodiments, the reachability notification message enables updating of an application function (AF) or a peer node of the reachability status of the non-3GPP device. The request for PDU session establishment or modification includes a User Plane Address and a Device ID associated with the non-3GPP device.

In some embodiments, the PCF may further transmit, to a unified data repository/unified data management (UDR/UDM) node, an update message including the User Plane Address, the Device ID associated with the non-3GPP device, and an identifier of the UE or 5G-RG through which the non-3GPP device is connecting. The update message may include an indication that the PCF is subscribing to updates regarding the non-3GPP device. The transceiver in the PCF may further receive a response, from the UDR/UDM, including an NEF ID. The transmitting the reachability notification message to the NEF may be based on the NEF ID.

In some embodiments, the PCF further receives a PDU session release message from the non-3GPP device via the user equipment (UE) or 5G residential gateway (5G-RG) through which the non- 3GPP device is connecting. The PCF may then transmit a second reachability notification message to the NEF based on receiving the PDU session release message from the non-3GPP device. The second reachability notification message may indicate to the NEF that the non-3GPP device is not reachable. The second reachability notification message enables updating of an application function (AF) or a peer node of the reachability status of the non-3GPP device. The PDU session release message may include a User Plane Address and a Device ID associated with the non-3GPP device.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2A is a first portion of a signal flow diagram according to an embodiment where a non-3GPP device connects to a 3GPP network via a UE/ 5G-RG;

FIG. 2B is a second portion of the signal flow diagram of FIG. 2A; and

FIG. 3 is a signal flow diagram according to an embodiment where a non-3GPP device releases a connection to a 3GPP network it had established via a UE/ 5G-RG.

### DETAILED DESCRIPTION

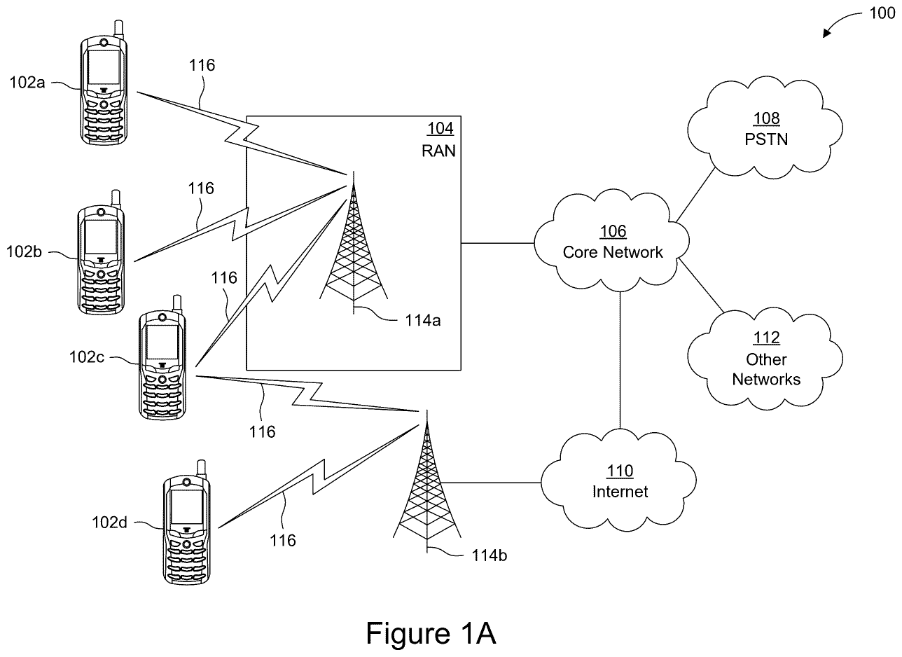

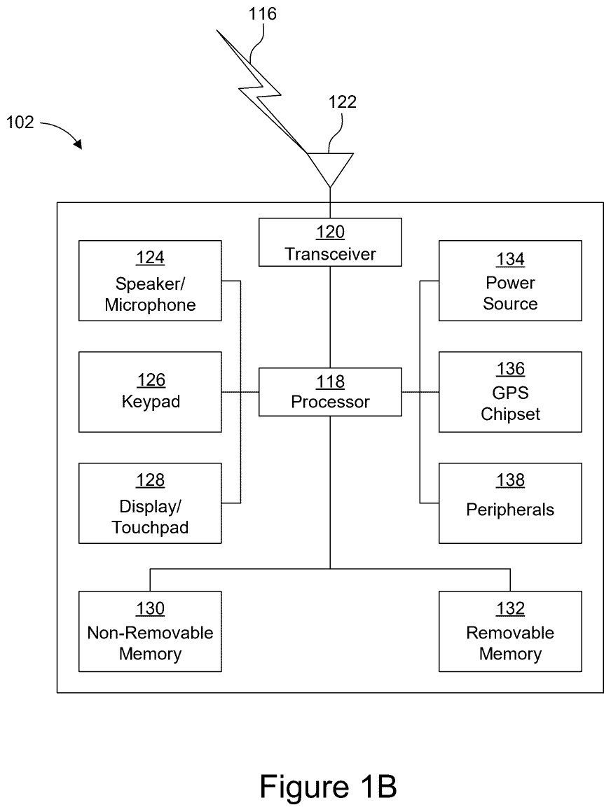

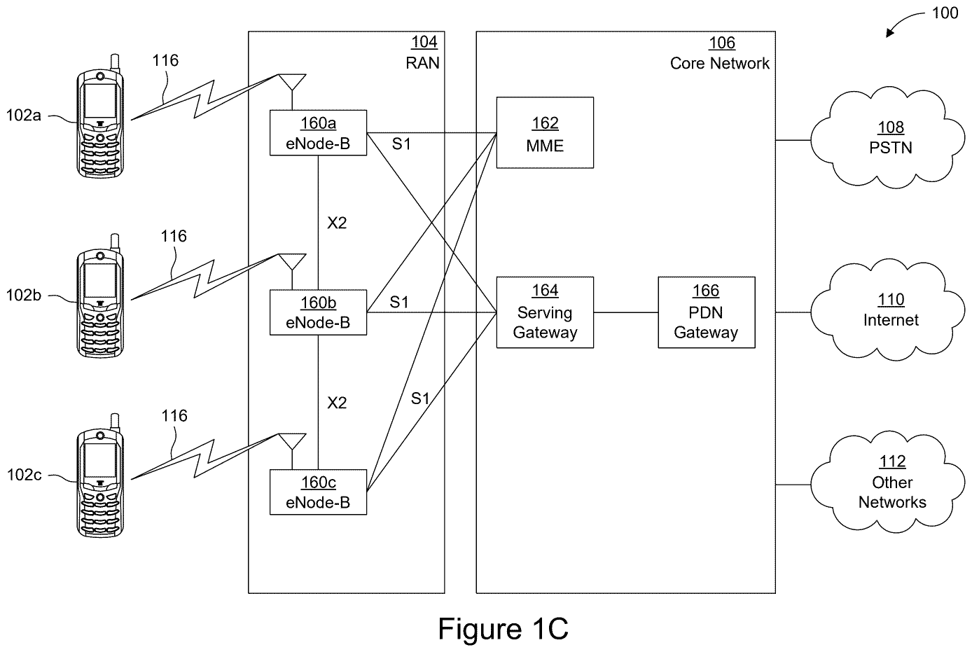

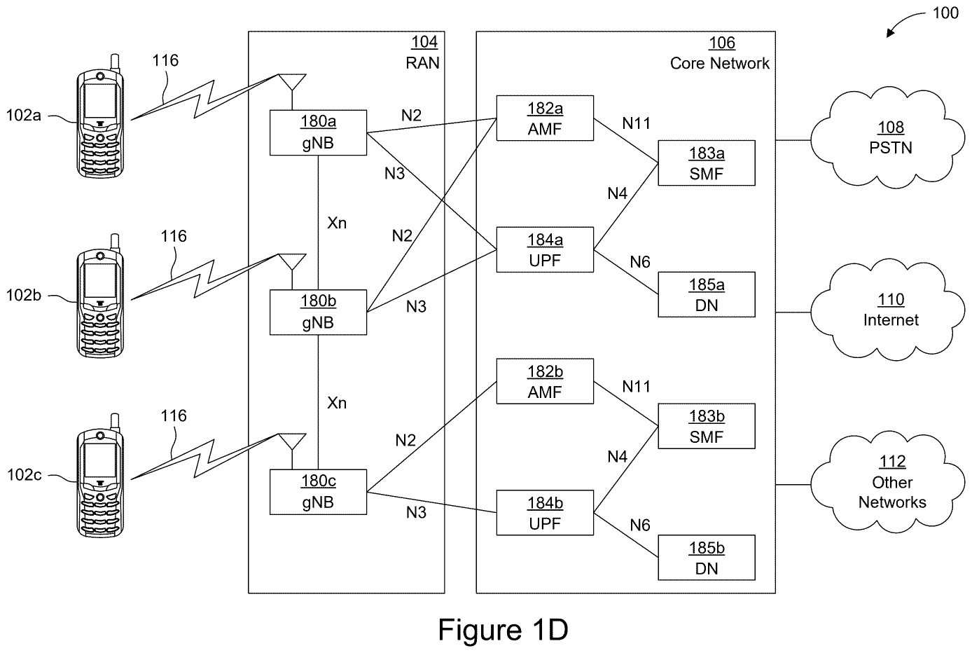

The following abbreviations are used herein:
6 6G System
AF Application Function
AMF Access and Mobility Management Function
DP Device Profile
ID Identity
NEF Network Exposure Function
NF Network Function
PCF Policy Control Function
RG Residential Gateway
RS Reachability Server
T&R Tracking and Reachability
UDM Unified Data Management
UDR Unified Data Repository
UE User Equipment
FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114 b and the WTRUs 102 c, 102 d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114 b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11 ah supports 1 MHz, 2 MHz, 4 MHz, 8 MHz, and 16 MHz bandwidths using non-TVWS spectrum. According to a representative embodiment, 802.11 ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

It is noted that in the embodiments disclosed herein the term WTRU and UE are used interchangeably. In the described embodiments, when UE is used, it is for convenience and not intended to limit the disclosure solely to a UE implementation. A WTRU may equally perform the described UE functions, and the term WTRU may be interchanged with the term UE throughout this document.

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a,184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

In embodiments described herein, a global non-3GPP device identifier may be associated with a user and/or platforms and/or domains. To reach a user via a non-3GPP device without the user having their own subscription to the network, and that obtain a communication service for the non-3GPP device through connecting to a UE or 5G-RG, it is necessary to know the UE/5G-RG ID that the non-3GPP device is connecting to. In addition, the peer node that wishes to communicate with the non-3GPP device needs to know how to reach the non-3GPP device among many other devices that may connect to the network through the same UE/5G-RG's ID, i.e., to identify addressing information the non-3GPP device is associated with.

Accordingly, this presents several issues. A first issue is how to locate and reach a non-3GPP device that does not have a network service subscription considering that the non-3GPP device may connect to the network for communication via any arbitrary UE/5G-RG (e.g., the non-3GPP device is not statically associated with the UE/5G-RG).

A second issue is how to enable a peer node to be notified when a non-3GPP device connects or disconnects to/from a UE/5G-RG. For example, to enable the peer node to know whether it can or cannot communicate with the device.

The embodiments described hereafter define functions and information flows needed to provide reachability management in a wireless system for a non-3GPP device that is not statically or permanently connected to a fixed UE/5G-RG.

The following embodiments describe the architecture and procedures that enable a non-3GPP device to be reached by a peer, when the non-3GPP device connects via a UE/5G-RG, or to determine that the non-3GPP device is not reachable (or not reachable anymore) when the non-3GPP device disconnects from the UE/5G-RG providing network services. The embodiments enable reachability of the non-3GPP device for communication, with the non-3GPP device being loosely associated (e.g., temporarily associated) to any network subscription. As the non-3GPP device may be linked or unlinked to/from different subscriptions/UE/NG-RGs at different times, the embodiments described here ensure the privacy of the UEs/5G-RGs through which the non-3GPP device connects.

The disclosed embodiments enable a wireless network operator to provide a service to end users and third-party applications that enables reachability and communication with subscription-less non-3GPP devices via a UE/5G-RG. The wireless network operator is able to control (e.g., for charging, security) whether a non-3GPP device can be reached by a peer node. For the end user, the disclosed embodiments enables several such non-3GPP devices to use network connectivity services via a UE/5G-RG while leveraging an existing (e.g., loosely coupled) network subscription.

The non-3GPP device information is stored in the UDR separate from any wireless network subscription information. Upon reception of a trigger, the AF may send a request to the NEF to subscribe to reachability notifications for the non-3GPP device, and the AF may provide an AF ID and/or an application ID to distinguish the non-3GPP device from a multiplicity of applications. The reachability notification subscription information is thus then configured in the UDM/UDR by the NEF. The subscription information includes the NEF ID and a subscription reference ID, and an application ID associated to the non-3GPP device.

After the AF subscribes to receive reachability update information associated with the non-3GPP device from the NEF, when the UDM/UDR receives a notification from the SMF that the non-3GPP device is connecting to a UE/5G-RG using a PDU Session, the UDM/UDR updates information stored in the UDR associated with the UE, and the information in the Device Information Profile in the UDR of the non-3GPP device. The SMF may also provide the non-3GPP device application ID, if provided by the non-3GPP device upon connection to the UE/5G-RG.

The UDM/UDR may send a notification to the AF via the NEF, the notification indicating that the non-3GPP device is reachable and may include one or more of the Reference ID, the UE ID, the User Plane Address, and/or the notification may also indicate an application ID that the non-3GPP device's session is bound to.

The AF may then create an external ID for the UE/5G-RG that the non-3gpp device is connected to protect the privacy of the UE/5G-RG. The external ID is mapped to the permanent UE/5G-RG ID upon request from a NF later during the reachability procedure. The non-3GPP device reachability at the AF is updated with the binding of the global device ID (or non-3GPP device user identity), the UE external ID, and the User Plane Address.

When the PCF receives a notification from the SMF that a non-3GPP device is using the PDU Session, the PCF retrieves the non-3GPP device profile information from the UDR. The PCF sends a notification to the NEF ID, the notification indicates that the non-3GPP device is reachable and includes the Reference ID, and/or non-3GPP device addressing info. Alternatively, the PCF (or SMF) updates addressing information in the UDR (e.g., as part of the exposure data in UDR]) which the NEF may query for exposure to AF.

A notification along with the binding information of the non-3GPP device global ID, UE/5G-RG external ID, and the User Plane Address at the UE/5G-RG is sent to the T&R client where the reachability activity on the non-3GPP device is carried out. The network may retrieve the permanent UE/5G-RG ID from the AF if the external ID is not known to the network when the reachability action is first performed.

When the PDU Session is released, the PCF may send a notification to the NEF ID, the notification indicates that the non-3GPP device is not reachable and includes the Reference ID. The notification also includes the non-3GPP device addressing info. The AF will then update the non-3GPP device reachability information and send the notification to the T&R client.

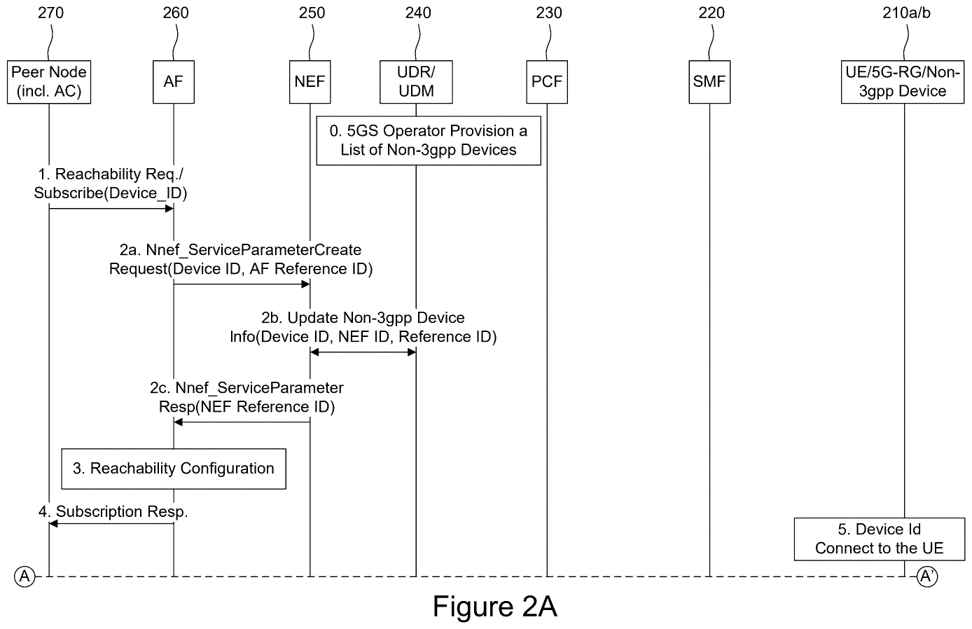

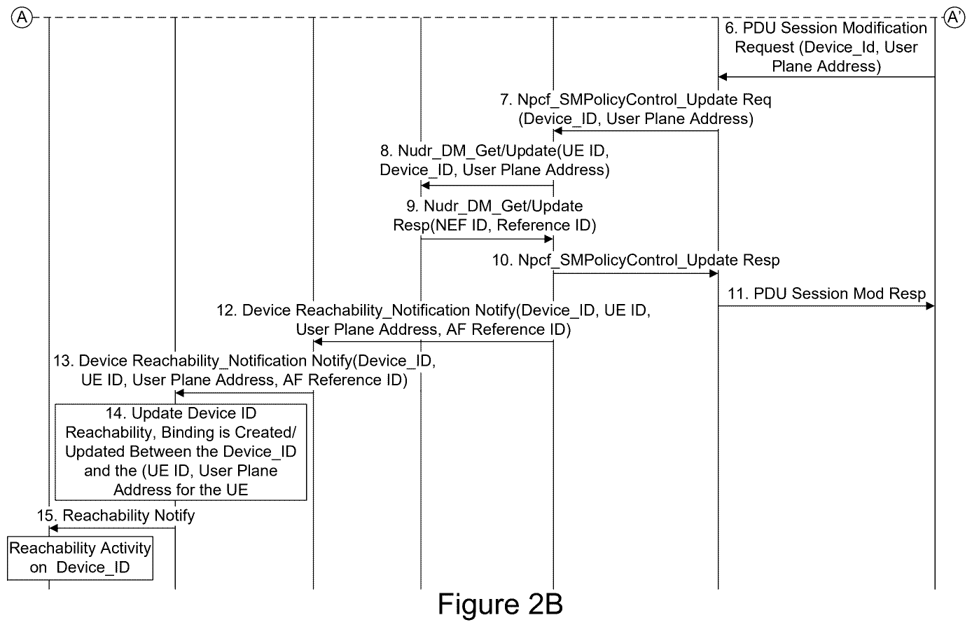

FIG. 2 is a signal flow diagram of an embodiment where an application function (AF) subscribes to receive notifications about the reachability of a non-3GPP device and then receives notifications about the reachability of the non-3GPP device. The embodiment is illustrated with the UE/5G-RG using a PDU Session Modification procedure but can be equally applied with the UE/5G-RG using a PDU Session Establishment procedure.

In step 0, information about non-3GPP device(s) 210a is provisioned in the UDR 240. It is noted that the reference numeral 210a is used it to refer to the non-3GPP device and the reference numeral 210b is used to refer to the UE/5G-RG to which it is connected. The information may be called a Device Profile. The information includes at least a Non-3GPP Device Identifier. The information may also include identifiers of slices (i.e. S-NSSAI(s)) and identifiers of Data Networks (i.e. DNN(s)) that the non-3GPP device 210a is allowed to access, and may include Application ID(s) associated with the non-3GPP device. For each DNN/S-NSSAI combination, the information may also include QoS Information. The QoS Information may indicate the type of QoS Information that the non-3GPP device 210a receive when accessing the DNN/S-NSSAI combination. The Application ID(s) may be provided instead of, or in addition to, the QoS Information. For example, the Application ID(s) may be used by the PCF 230 to determine what QoS is required by the non-3GPP device 210a. The information may be stored in the UDR 240 such that it is independent of a UE subscription. Thus, the data key for accessing the information may be the non-3GPP Device Identifier.

In step 1, a Peer Node 270, including an application client, communicates a Reachability Request to the AF 260 in order to subscribe to reachability information associated with the non-3GPP device 210a. The Reachability Request may identify the non-3GPP device 210a by its Device ID.

In step 2a the AF 260 determines that it needs to determine whether a non-3GPP device 210a is reachable, what UE/5G-RG the non-3GPP device 210a is using to access the wireless system, and the user plane address of the non-3GPP device 210a. When the AF 260 makes this determination, the AF 260 invokes a service of the NEF 250. In the service invocation, the AF 260 may indicate that it wants to register for a reachability notification for the non-3GPP device 210a. The Non-3GPP Device Identifier may be used by the AF 260 to identify the non-3GPP device 210a in the service invocation. This request may be an invocation of the Nnef_ServiceParameter_Create service operation. The request may includes at least the non-3GPP Device Identifier. The request may also include an AF Reference ID. The AF 260 may create the AF Reference ID and associate the AF Reference ID with the reachability subscription that it is requesting. In other words, the AF 260 may associate the AF Reference ID with the subscription for reachability of the Non-3GPP Device Identifier.

In step 2b, the NEF 250 sends a request to the UDM/UDR 240 to store information about the reachability subscription in the Device Profile of the non-3GPP device 210a. The request includes the non-3GPP Device Identifier. The Non-3GPP Device Identifier is used as the data key to identify what information in the UDR/UDM 240 needs to be updated. The information includes an NEF ID. The NEF ID is the identity of the NEF and it is stored in the UDM/UDR 240 as a way of indicating where reachability notifications for the device need to be sent. The information can include the AF Reference ID or an NEF Reference ID.

An NEF Reference ID is an identifier that is created by the NEF 250 and associated with the AF Identifier. The NEF 250 may store information about which AF Identifier is associated with the NEF Reference ID.

The AF Reference ID or NEF Reference ID may be stored in the Device Profile so that the AF Reference ID or NEF Reference ID may be included in a reachability notification so that the NEF can determine what subscription notification the notification is associated with.

In step 2b, the UDM/UDR 240 will respond to the NEF's 250 service invocation and indicate that the reachability subscription information has been stored. The NEF 250 may use Nudr_DM_Create/Update/Delete service operation to update parameters in step 2b.

In step 2c, the NEF 250 responds to the AF 260 with an indication that the reachability subscription has been created. The notification may include the NEF Reference ID, for example, if the AF 260 provided no AF Reference ID. Then, the NEF Reference ID may be provided to the AF 260. T

In step 3, he AF 260 may then store an association of the NEF Reference ID to the reachability subscription. Later, when the AF 260 receives a reachability notification, the notification may include the NEF Reference ID or the AF Reference ID.

In step 4, the AF 260 sends an acknowledgement message to the peer node 270. The message may include reachability information of the non-3GPP device 210a if obtained from the NEF 250. How the peer node 270 uses the reachability information is described below.

In step 5, unrelated to steps 0 through 4, the non-3GPP device 210a may connect to a UE/5G-RG 210b that can provide network service to the device based on the mutual agreement between the non-3GPP device 210a and UE/5G-RG 210b. For example, the non- 3GPP device 210a may have been configured with a password that can be used to connect to the UE/5G-RG 210b via Wi-Fi.

In step 6, the connection of the non- 3GPP device 210a to the UE/5G-RG 210b triggers the UE/5G-RG 210b to send a PDU Session Modification Request to the SMF 220. The message includes the Non-3GPP Device Identifier and the user plane address of the non-3GPP device 210a.

In step 7, when the PCF 230 receives a notification from the SMF 220 that a non-3GPP device 210a is using the PDU Session, the PCF 230 retrieves the profile information from the UDR/UDM 240 of the UE/ 5G-RG 210b. The notification includes the non-3GPP Device Identifier and the user plane address of the non-3GPP device 210a.

In Step 8, the PCF 230 sends a request to the UDR/UDM 240 to retrieve QoS Information for the non-3GPP device 210a and provide the UDR/UDM 240 with the user plane address of the non-3GPP device 210a and the External Identifier of the UE/5G-RG 210b that the non-3GPP device 210a is using to access the network. This request includes the non-3GPP Device Identifier and the user plane address.

In step 9, the UDR/UDM 240 stores the External Identifier and the user plane address in the Device Profile. The UDR/UDM 240 then sends a response to the PCF 230. The response message to the PCF 230 may include the QoS Information for the non-3GPP device 210a, the NEF ID, and an AF Reference ID or an NEF Reference ID.

In step 10, the PCF 230 sends PCC Rules to the SMF 220.

In step 11, the SMF 220 uses the PCC Rules to update the QoS Rules, QoS Profiles, and N4 Rules for the PDU Session and sends a PDU Session Modification Response to the UE/5G-RG 210.

In step 12, the PCF 230 sends a reachability notification to the NEF ID, the notification indicates that the non-3GPP device 210a is reachable and includes the subscription AF Reference ID or NEF Reference ID. The notification optionally includes the user plane address of the non-3GPP device 210a. The notification optionally includes External ID of the UE/5G-RG 210b. The notification optionally includes the Non-3GPP Device Identifier. The Non-3GPP Device Identifier may not need to be included in the notification since the NEF 250 could have stored information that indicates the Non-3GPP Device Identifier is associated with the AF Reference ID or NEF Reference ID. The reachability notification may include an indication that the reason for the reachability notification is that the non-3GPP device 210a is reachable. Alternatively, the presence of the user plane address can be an indication that the device is reachable.

In step 13, the NEF 250 sends the reachability notification to the AF 260. The reachability notification indicates that the non-3GPP device 210a is reachable and includes the subscription AF Reference ID or Non-3GPP Device Identifier. The reachability notification optionally includes the user plane address. The reachability notification optionally includes External ID of the UE/5G-RG 210b. The reachability notification optionally includes the Non-3GPP Device Identifier. The Non-3GPP Device Identifier may not need to be include in the reachability notification since the AF 260 could have stored information that indicates the non-3GPP Device Identifier is associated with the AF Reference ID. The reachability notification may include an indication that the reason for the reachability notification is that the non-3GPP device 210a is reachable. Alternatively, the presence of the user plane address can be an indication that the non-3GPP device 210a is reachable.

In Step 14, the AF 260 updates locally the reachability information of the non-3GPP device 210a.

In Step 15, the AF 260 sends a notification to the peer node 270 providing reachability information of the non-3GPP device 210a (e.g., user plane address). The peer node 270 may initiate communication with the non-3GPP device 210a using the provided user plane address.

In some embodiments, a reachability notification may be issued when a non-3GPP device is already connected to a UE/5G-RG. In a first alternative, in the signal flow of FIG. 2, the non-3GPP device 210 amay have already been connected to the UE/5G-RG 210b when the NEF 250 stores reachability notification information in the UDR/UDM 240. One approach to handling this scenario is for the update of the Device Profile information to trigger a notification to be sent from the UDR/UDM 240 to the PCF 230. In other words, the addition of the reachability subscription information to the profile will trigger a reachability notification be sent to the PCF 230 because the PCF 230 would have previously subscribed to the UDR/UDM 240 to receive reachability notifications when the Device Profile information is updated (i.e. when the non-3GPP device 210a connects to the network). During the PDU Session Modification procedure, the PCF 230 would have previously indicated to the UDR/UDM 240 that the PCF 230 wants to be notified when the Device Profile information is updated. The reachability notification from the UDR/UDM 240 to the PCF 230 will include the NEF ID, and an AF Reference ID or an NEF Reference ID. Reception of the reachability notification will trigger the PCF 230 to send the reachability notification to the NEF ID.

In a second alternative, a reachability notification may be issued when a non-3GPP device is already Connected to a UE/5G-RG. In the signal flow of FIG. 2, the non-3GPP device 210a may have already been connected to the UE/5G-RG 210b when the NEF 250 stores reachability notification information in the UDR/UDM 240. A second approach to handling this scenario is for the update of the Device Profile information to trigger a reachability notification to be sent from the UDR/UDM 240 to the NEF 250. In other words, the addition of the reachability subscription information to the profile will trigger the UDR/UDM 240 to send a reachability notification to the NEF 250 because the UDR/UDM 240 will detect that the non-3GPP device 210a is reachable based on the presence of a user plane address for the non-3GPP device 210a in the Device Profile.

The UDR/UDM 240 may notify the NEF 250 that the non-3GPP device 210a is reachable when it sends a response to the NEF 250 in step 2b of the signal flow shown in FIG. 2.

The NEF 250 may notify the AF 260 that the non-3GPP device 210a is reachable, as described in step 13 of the signal flow in FIG. 2.

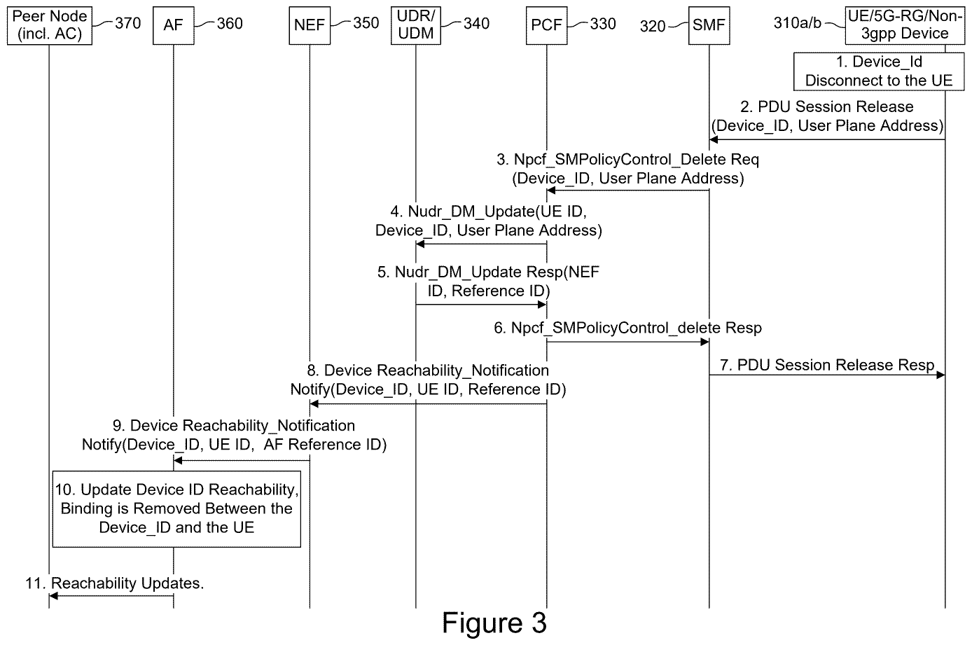

In other embodiments, a reachability notification may be sent when a non-3GPP device disconnects from a UE/5G-RG. FIG. 3 shows a signal flow diagram of a procedure that provides a reachability notification when a non-3gpp device disconnects from a UE/5G-RG. It should be understood that the signal flow of FIG. 3 is not an alternative to the signal flow of FIG. 2. Rather, the procedure of FIG. 2 may be performed and then subsequently the procedure of FIG. 3 may be performed.

When a PDU Session is released after the disconnection of a non-3GPP device 310a, the PCF 330 sends a reachability notification to the NEF ID, the reachability notification indicates that the non-3GPP device 310a is not reachable along with the NEF Reference ID or AF Reference ID.

In step 1, the connection between the non-3GPP device 310 and the UE/5G-RG 310 is released. It is noted that the reference numeral 310a is used it to refer to the non-3GPP device and the reference numeral 310b is used to refer to the UE/5G-RG.

In step 2, the UE/5G-RG 310b sends a PDU Session Release message or a PDU Session Modification message to the SMF 320. If a PDU Session Modification is sent, then the message includes the non-3GPP Device Identifier associated with the non-3GPP device 310a and an indication that the non-3GPP device 310a is no longer connected to the UE/5G-RG 310b.

In step 3, the PCF 330 receives a reachability notification from the SMF 320 that the PDU Session is released or that the non-3GPP device 310a is no longer connected to the UE/5G-RG 310b. If the reachability notification is not triggered by a PDU Session Release, then the reachability notification includes the Non-3GPP Device Identifier and an indication that the non-3GPP device 310a is no longer connected to the UE/5G-RG 310b.

In step 4, the PCF 330 sends a message to the UDR/UDM 340 to trigger the removal of the user plane address and External ID from the Device Profile associated with the non-3GPP device 310a.

In step 5, the UDR/UDM sends a response to the PCF 330 to acknowledge the message of step 4.

In step 6, the PCF 330 sends a response back to the SMF 320 to acknowledge the request of step 3.

In step 7, the SMF 320 sends a response back to the UE.

In step 8, the PCF 330 sends a reachability notification to the NEF ID, the reachability notification indicates that the non-3GPP device 310a is not reachable and includes the subscription AF Reference ID or NEF Reference ID. The reachability notification optionally includes the Non-3GPP Device Identifier. The Non-3GPP Device Identifier may not need to be include in the reachability notification since the NEF 350 could have stored information that indicates which Non-3GPP Device Identifier is associated with the AF Reference ID or NEF Reference ID. The reachability notification may include an indication that the reason for the reachability notification is that the non-3GPP device 310a is not reachable. Alternatively, the presence of no user plane address in the reachability notification can be an indication that the non-3GPP device 310a is not reachable.

In step 9, the NEF 350 sends the reachability notification to the AF 360. The reachability notification indicates that the device is not reachable and includes the subscription AF Reference ID or Non-3GPP Device Identifier. The reachability notification optionally includes the Non-3GPP Device Identifier. The Non-3GPP Device Identifier may not need to be include in the reachability notification since the AF 360 could have stored information that indicates which Non-3GPP Device Identifier is associated with the AF Reference ID. The reachability notification may include an indication that the reason for the reachability notification is that the non-3GPP device 310a is not reachable. Alternatively, the presence of no user plane address may be an indication that the non-3GPP device 310a is not reachable.

In step 10, the AF 360 updates the non-3GPP device reachability, and the binding is removed between the non-3GPP device 310a and the UE/5G-RG 310b.

In step 11, the peer node 370 is notified about the updated reachability of the non-3GPP device 310a that has disconnected from the UE/5G-RG 310b.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A Policy Control Function (PCF) for use in a Third Generation Partnership Project (3GPP) wireless network, the PCF comprising:
a transceiver; and
a processor, wherein the transceiver and the processor are configured to:
receive a request for a packet data unit (PDU) session establishment or modification from a user equipment (UE) or 5G residential gateway (5G-RG) through which a non-3GPP device is connecting; and
transmit a reachability notification message to a network exposure function (NEF) based on receiving the request for establishment of the PDU session from the non-3GPP device, wherein the reachability notification message indicates to the NEF that the non-3GPP device is reachable.

2. The PCF of claim 1, wherein the reachability notification message enables updating of an application function (AF) or a peer node of a reachability status of the non-3GPP device.

3. The PCF of claim 1, wherein the request for PDU session establishment or modification includes a User Plane Address and a Device ID associated with the non-3GPP device.

4. The PCF of claim 3, wherein the transceiver and the processor are further configured to transmit, to a unified data repository/unified data management (UDR/UDM) node, an update message including the User Plane Address, the Device ID associated with the non-3GPP device, and an identifier of the UE or 5G-RG through which the non-3GPP device is connecting.

5. The PCF of claim 4, wherein the update message includes an indication that the PCF is subscribing to updates regarding the non-3GPP device, and wherein the transceiver is further configured to receive a response, from the UDR/UDM, including an NEF ID, wherein the transmitting the reachability notification message to the NEF is based on the NEF ID.

6. The PCF of claim 1, wherein the transceiver and the processor are further configured to:
receive a PDU session release message from the non- 3GPP device via the user equipment (UE) or 5G residential gateway (5G-RG) through which the non-3GPP device is connecting; and
transmit a second reachability notification message to the NEF based on receiving the PDU session release message from the non-3GPP device, wherein the second reachability notification message indicates to the NEF that the non-3GPP device is not reachable.

7. The PCF of claim 6, wherein the second reachability notification message enables updating of an application function (AF) or a peer node of the reachability status of the non-3GPP device.

8. The PCF of claim 6, wherein the PDU session release message includes a User Plane Address and a Device ID associated with the non-3GPP device.

9. A method for use in a Policy Control Function (PCF) in a Third Generation Partnership Project (3GPP) wireless network, the method comprising:
receiving a request for a packet data unit (PDU) session establishment or modification from a user equipment (UE) or 5G residential gateway (5G-RG) through which a non-3GPP device is connecting; and
transmitting a reachability notification message to a network exposure function (NEF) based on receiving the request for establishment of the PDU session from the non-3GPP device, wherein the reachability notification message indicates to the NEF that the non-3GPP device is reachable.

10. The method of claim 9, wherein the reachability notification message enables updating of an application function (AF) or a peer node of a reachability status of the non-3GPP device.

11. The method of claim 9, wherein the request for PDU session establishment or modification includes a User Plane Address and a Device ID associated with the non-3GPP device.

12. The method of claim 11, further comprising:
transmitting, to a unified data repository/unified data management (UDR/UDM) node, an update message including the User Plane Address, the Device ID associated with the non-3GPP device, and an identifier of the UE or 5G-RG through which the non-3GPP device is connecting.

13. The method of claim 12, wherein the update message includes an indication that the PCF is subscribing to updates regarding the non-3GPP device, further comprising:
receiving a response, from the UDR/UDM, including an NEF ID, wherein the transmitting the reachability notification message to the NEF is based on the NEF ID.

14. The method of claim 9, further comprising:
receiving a PDU session release message from the non-3GPP device via the user equipment (UE) or 5G residential gateway (5G-RG) through which the non-3GPP device is connecting; and
transmitting a second reachability notification message to the NEF based on receiving the PDU session release message from the non-3GPP device, wherein the second reachability notification message indicates to the NEF that the non-3GPP device is not reachable.

15. The method of claim 14, wherein the second reachability notification message enables updating of an application function (AF) or a peer node of the reachability status of the non-3GPP device.

16. The method of claim 14, wherein the PDU session release message includes a User Plane Address and a Device ID associated with the non-3GPP device.
